(19) United States
(12) Patent Application Publication
(10) Pub. No.: US 2026/0085467 A1
(43) Pub. Date: Mar. 26, 2026

(54) POLYHYDROXYALKANOATE-BASED FABRIC AND ARTICLES COMPRISING THE SAME

(71) Applicant: NEOX Public Benefit LLC, New York, NY (US)

(72) Inventors: Neri Oxman, New York, NY (US); Jessica Lu, New York, NY (US); Andrea H. Westlie, New York, NY (US); Markus A.R. Kayser, New York, NY (US); Luis Ruben Soenksen Martinez, New York, NY (US)

(21) Appl. No.: 19/340,078

(22) Filed: Sep. 25, 2025

Related U.S. Application Data
(60) Provisional application No. 63/698,676, filed on Sep. 25, 2024.

(51) Int. Cl. D06M 15/507; C08G 63/06; D03D 15/587

(52) U.S. Cl. CPC D06M 15/507; C08G 63/06; D03D 15/587

(57) ABSTRACT

A polyhydroxyalkanoate-based fabric is disclosed. The fabric comprises a fabric section comprising a first fiber comprising a fiber forming material at least partially coated with a polyhydroxyalkanoate. The fabric may comprise a first fabric section and a second fabric section. The first fabric section may comprise a plurality of fibers comprising a first fiber comprising a fiber forming material and a second fiber comprising a polyhydroxyalkanoate wherein the fiber forming material has a melting temperature or a degradation temperature higher than a melting temperature of the polyhydroxyalkanoate. The second fabric section may comprise the first fiber extending from the first fabric section wherein the first fiber is at least partially coated with the polyhydroxyalkanoate present in the second fabric section. The second fabric section may have a higher tensile modulus than the first fabric section.

### CROSS-REFERENCE TO RELATED APPLICATION

The present application claims filing benefit of U.S. Provisional Patent Application No. 63/698,676 having a filing date of Sep. 25, 2024, which is hereby incorporated by reference in its entirety.

### BACKGROUND

Polymers, whether natural or synthetic, are often used in numerous and diverse applications. Particularly, polyesters, such as polyhydroxyalkanoates, may be utilized in various applications due to the ability to tailor the properties of the specific polyesters for a given application. As one example, such polyesters may be utilized for articles, including apparel and garments, due to their properties and processing capabilities. However, depending on the particular application, such as apparel and garments, it may be desired to have a fabric exhibiting certain properties. In addition, it may be desired to have different properties within respective sections of a given article. Currently, such selective placement of properties can be achieved by overlying fabric or film or connecting different pieces of fabric. As a result, manufacturing such articles typically requires additional processing steps which may be complex and/or costly.

As such, a need currently exists for providing an improved fabric and resulting article that can exhibit desired properties.

### SUMMARY OF THE DISCLOSURE

In accordance with one embodiment of the present disclosure, a polyhydroxyalkanoate-based fabric is disclosed. The fabric comprises a fabric section comprising a first fiber comprising a fiber forming material at least partially coated with a polyhydroxyalkanoate.

In accordance with another embodiment of the present disclosure, a polyhydroxyalkanoate-based fabric is disclosed. The fabric comprises a first fabric section and a second fabric section. The first fabric section comprises a plurality of fibers comprising a first fiber comprising a fiber-forming material and a second fiber comprising a polyhydroxyalkanoate wherein the fiber-forming material has a melting temperature or a degradation temperature higher than a melting temperature of the polyhydroxyalkanoate. The second fabric section comprises the first fiber extending from the first fabric section wherein the first fiber is at least partially coated with the polyhydroxyalkanoate present in the second fabric section. The second fabric section has a higher tensile modulus than the first fabric section.

In accordance with another embodiment of the present disclosure, a method of making a continuous polyhydroxyalkanoate-based fabric is disclosed. The method comprises providing a fabric comprising a fabric section comprising a first fiber comprising a fiber-forming material and a second fiber comprising a polyhydroxyalkanoate wherein the fiber-forming material has a melting temperature or a degradation temperature higher than a melting temperature of the polyhydroxyalkanoate. The method further comprises subjecting the fabric section to a temperature equal to or greater than the melting temperature of the polyhydroxyalkanoate such that the second fiber comprising the polyhydroxyalkanoate melts to at least partially coat the first fiber.

In accordance with another embodiment of the present disclosure, a method of making a continuous polyhydroxyalkanoate-based fabric is disclosed. The method comprises providing a fabric comprising a first fabric section and a second fabric section. The first fabric section comprises a plurality of fibers comprising a fiber-forming material and a second fiber comprising a polyhydroxyalkanoate wherein the fiber-forming material has a melting temperature or a degradation temperature higher than a melting temperature of the polyhydroxyalkanoate. The second fabric section comprises the first fiber extending from the first fabric section and the second fiber extending from the first fabric section. The method further comprises subjecting the second fabric section to a temperature equal to or greater than the melting temperature of the polyhydroxyalkanoate such that the second fiber comprising the polyhydroxyalkanoate of the second fabric section melts to at least partially coat the first fiber of the second fabric section.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a polyhydroxyalkanoate-based fabric. The fabric includes a fabric section formed from multiple types of fibers and/or yarns wherein at least one fiber comprising a polyhydroxyalkanoate, whether alone or as part of a yarn, is exposed to a temperature greater than the melting temperature of such fiber such that it coats another fiber, particularly one formed from a material having a melting temperature greater than the heat exposure temperature. In this regard, the form of the polyhydroxyalkanoate may be different pre-and post-heat exposure in order to provide a fabric section and corresponding fabric with desired properties.

In certain embodiments, multiple sections may be included in the fabric such that the respective fabric sections have different mechanical properties. For instance, in such embodiments, the fabric may include at least a first fabric section and a second fabric section, each having one or more different mechanical properties. In addition, the form of the polyhydroxyalkanoate may be different as further defined herein in each of the respective sections in order to attain desired properties.

In this regard, to the extent the fabric includes multiple sections, a fabric and resulting article may have some degree of continuity between a respective first fabric section and a second fabric section. In particular, as defined herein, the first fabric section and the second fabric section are continuous. For instance, the first fabric section comprises a plurality of fibers comprising a first fiber comprising a fiber-forming material and a second fiber comprising a polyhydroxyalkanoate, and the second fabric section comprises the first fiber extending from the first fabric section wherein the first fiber is at least partially coated with the polyhydroxyalkanoate. Accordingly, the first fiber extends from the first fabric section to the second fabric section. As a result, such sections are continuous. In this regard, such first fiber and first fabric section are not stitched, sewed, glued, overlayed, etc. between such respective sections. Similarly, such fabric sections are not combined by stitching, sewing, gluing, or using overlays.

Furthermore, due to the processing as defined herein, the polyhydroxyalkanoate fiber (or second fiber comprising the polyhydroxyalkanoate) has melted in the fabric section, such as the second fabric section, such that it at least partially coats the first fiber. Meanwhile, the second fiber is still present in the first fabric section. Accordingly, both the first fabric section and the second fabric section contain the polyhydroxyalkanoate albeit in different forms. However, prior to the processing at the elevated temperatures as disclosed herein, such second fiber also extends from the first fabric section to the second fabric section. In this regard, such second fiber was also present in the second fabric section in a fiber form prior to the processing at elevated temperatures.

By providing such a fabric as disclosed herein, a resulting article may have desired properties and characteristics, particularly in selective areas. For instance, the fabric and resulting article may be tailored to provide desired elastic or stiffness properties, particularly in selective areas. In addition, such desired properties may be obtained by minimizing processing steps typically required in order to obtain an article having such properties.

For example, without intending to be limited, a higher tensile modulus may provide a fabric that may resist movement. In this regard, the first fabric section may have a lower tensile modulus than the second fabric section. For instance, the tensile modulus of the second fabric section may be 1% or more, such as 3% or more, such as 5% or more, such as 10% or more, such as 20% or more, such as 30% or more, such as 40% or more, such as 50% or more, such as 60% or more, such as 70% or more, such as 80% or more, such as 90% or more, such as 100% or more, such as 125% or more, such as 150% or more, such as 175% or more, such as 200% or more, such as 225% or more, such as 250% or more, such as 275% or more, such as 300% or more, such as 325% or more, such as 350% or more, such as 375% or more, such as 400% or more, such as 425% or more, such as 450% or more, such as 475% or more, such as 500% or more, such as 550% or more, such as 600% or more, such as 650% or more, such as 700% or more, such as 750% or more, such as 800% or more, such as 850% or more, such as 900% or more, such as 950% or more, such as 1000% or more, such as 1100% or more, such as 1200% or more, such as 1300% or more, such as 1400% or more, such as 1500% or more than the tensile modulus of the first fabric section. The tensile modulus of the second fabric section may be 3000% or less, such as 2800% or less, such as 2600% or less, such as 2400% or less, such as 2200% or less, such as 2000% or less, such as 1800% or less, such as 1600% or less, such as 1400% or less, such as 1200% or less, such as 1000% or less, such as 900% or less, such as 800% or less, such as 700% or less, such as 600% or less, such as 500% or less, such as 450% or less, such as 400% or less, such as 350% or less, such as 300% or less, such as 250% or less, such as 200% or less, such as 180% or less, such as 160% or less, such as 140% or less, such as 120% or less, such as 100% or less than the tensile modulus of the first fabric section. In general, the tensile modulus may be determined at a temperature of 23° C. in accordance with ASTM D4964-96(2020).

Further, the ratio of the tensile modulus of the first fabric section to the tensile modulus of the second fabric section may be less than 1. For instance, the ratio may be 0.0001 or more, such as 0.0005 or more, such as 0.001 or more, such as 0.005 or more, such as 0.01 or more, such as 0.05 or more, such as 0.1 or more, such as 0.2 or more, such as 0.3 or more, such as 0.4 or more, such as 0.5 or more, such as 0.6 or more. The ratio may be less than 1, such as 0.9 or less, such as 0.8 or less, such as 0.7 or less, such as 0.6 or less, such as 0.5 or less, such as 0.4 or less, such as 0.3 or less, such as 0.25 or less, such as 0.2 or less, such as 0.15 or less, such as 0.1 or less, such as 0.08 or less, such as 0.06 or less, such as 0.04 or less, such as 0.03 or less, such as 0.02 or less, such as 0.01 or less.

In addition, the first fabric section may have a lower elongation than the second fabric section. The ratio of the elongation of the first fabric section to the tensile modulus of the second fabric section may be less than 1. For instance, the ratio may be 0.0001 or more, such as 0.0005 or more, such as 0.001 or more, such as 0.005 or more, such as 0.01 or more, such as 0.05 or more, such as 0.1 or more, such as 0.2 or more, such as 0.3 or more, such as 0.4 or more, such as 0.5 or more, such as 0.6 or more. The ratio may be less than 1, such as 0.9 or less, such as 0.8 or less, such as 0.7 or less, such as 0.6 or less, such as 0.5 or less, such as 0.4 or less, such as 0.3 or less, such as 0.25 or less, such as 0.2 or less, such as 0.15 or less, such as 0.1 or less, such as 0.08 or less, such as 0.06 or less, such as 0.04 or less, such as 0.03 or less, such as 0.02 or less, such as 0.01 or less. In general, the elongation may be determined at a temperature of 23° C. in accordance with ASTM D4964-96(2020).

Various embodiments of the present disclosure will now be described in more detail.

### I. Polyhydroxyalkanoate Composition

As indicated herein, at least some of the fibers and/or yarns of the plurality of fibers and/or yarns of the fabric, particularly a respective fabric section, are made from a polyhydroxyalkanoate. In one embodiment, such fibers and/or yarns may be made from a polyhydroxyalkanoate composition comprising a polyhydroxyalkanoate. In addition, the polyhydroxyalkanoate composition may also include other additives as generally known in the art.

### A. Polyhydroxyalkanoate

As indicated above, the polyhydroxyalkanoate composition includes a polyhydroxyalkanoate. Without intending to be limited, polyhydroxyalkanoates are generally biodegradable polyesters. The polyhydroxyalkanoate may be one as generally known in the art.

The polyhydroxyalkanoate may be produced biologically or synthetically. In one embodiment, the polyhydroxyalkanoate may be a biologically produced polyhydroxyalkanoate. For instance, such polyhydroxyalkanoate may be produced by certain bacteria, which are not necessarily limited by the present disclosure. In particular, such polyhydroxyalkanoate may be produced, although not limited, by fermentation processes. In another embodiment, the polyhydroxyalkanoate may be a synthetically produced polyhydroxyalkanoate. For instance, such polyhydroxyalkanoate may be produced by chemically reacting respective monomers for the synthesis of the polyhydroxyalkanoate.

Further, the polyhydroxyalkanoate may be a homopolymer or a copolymer. In one embodiment, the polyhydroxyalkanoate may be a homopolymer. In another embodiment, the polyhydroxyalkanoate may be a copolymer.

The polyhydroxyalkanoate may comprise one or more monomeric units. In general, the monomeric unit may have the following formula:

—OCR¹R²(CR³R⁴)ₙCO—

wherein
n is an integer; and
R¹, R², R³, and R⁴ independently can be hydrocarbon radicals; halo-and hydroxy-substituted radicals; hydroxy radicals; halogen radicals; nitrogen-substituted radicals; oxygen-substituted radicals; and/or hydrogen atoms.

As indicated above, “n” is an integer. For instance, “n” may be from 1 to 15, such as from 1 to 10, such as from 1 to 8, such as from 1 to 5, such as from 1 to 4, such as from 1 to 3, such as from 1 to 2, such as 1. In this regard, “n” may be 1 or more, such as 2 or more, such as 3 or more. Also, “n” may be 15 or less, such as 12 or less, such as 10 or less, such as 8 or less, such as 6 or less, such as 5 or less, such as 4 or less, such as 3 or less, such as 2 or less. In one embodiment, “n” may be 1. Such embodiments may correspond to 3-hydroxyacids. In another embodiment, “n” may be 2. Such embodiments may correspond to 4-hydroxyacids. In another embodiment, “n”may be 3. Such embodiments may correspond to 5-hydroxyacids.

As indicated above, R¹, R², R³, and R⁴ independently can be a hydrocarbon radical; a halo-and hydroxy-substituted radical; a hydroxy radical; a halogen radical; a nitrogen-substituted radical; an oxygen-substituted radical; or a hydrogen atom. For example, R¹, R², R³, and R⁴ independently can be a hydrocarbon radical or a hydrogen atom. In one embodiment, a respective R group may be a hydrogen atom. In another embodiment, a respective R group may be a hydrocarbon radical.

The hydrocarbon radical may be an alkyl radical. The alkyl radical may be a C₁-C₂₀ alkyl radical, such as a C₁-C₁₆ alkyl radical, such as a C₁-C₁₂ alkyl radical, such as a C₁-C₈ alkyl radical, such as a C₁-C₆ alkyl radical, such as a C₁-C₄ alkyl radical, such as a C₁-C₂ alkyl radical, such as a C₁ alkyl radical. For instance, such radical may have 1 or more, such as 2 or more, such as 3 or more, such as 4 or more, such as 5 or more, such as 6 or more carbon atoms. Such alkyl radical may have 20 or less, such as 18 or less, such as 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, such alkyl radical may have 1 carbon atom such that it is a methyl group.

The polyhydroxyalkanoate may comprise one or more monomeric units including, but not limited to, 2-hydroxybutyrate, glycolic acid, 3-hydroxybutyrate, 3-hydroxypropionate, 3-hydroxyvalerate, 3-hydroxyhexanoate, 3-hydroxyheptanoate, 3-hydroxyoctanoate, 3-hydroxynonanoate, 3-hydroxydecanoate, 3-hydroxydodecanoate, 4-hydroxybutyrate, 4-hydroxyvalerate, 5-hydroxyvalerate, 6-hydroxyhexanoate, and mixtures thereof. However, it should be understood that the polyhydroxyalkanoate may also include other monomeric units not expressly recited herein.

As indicated herein, in one embodiment, the polyhydroxyalkanoate may be a homopolymer. The homopolymer may include a hydroxyalkanoate monomeric unit, such as one having a monomeric unit as described above.

Examples of polyhydroxyalkanoate homopolymers may include, but are not limited to, poly-3-hydroxyalkanoates (e.g., poly-3-hydroxypropionate (P3HP), poly-3-hydroxybutyrate (P3HB), poly-3-hydroxyvalerate (P3HV), poly-3-hydroxyhexanoate (P3HH), poly-3-hydroxyoctanoate (P3HO), poly-3-hydroxydecanoate (P3HD), and poly-3-hydroxy-5-phenylvalerate (P3H5PV)), poly-4-hydroxyalkanoates (e.g., poly-4-hydroxybutyrate (P4HB) and poly-4-hydroxyvalerate (P4HV)), and poly-5-hydroxyalkanoates (e.g., poly-5-hydroxyvalerate (P5HV)), etc. In one embodiment, the polyhydroxyalkanoate may be a poly 3-hydroxyalkanoate. For instance, in one embodiment, the polyhydroxyalkanoate may be poly-3-hydroxybutyrate (P3HB). In another embodiment, the polyhydroxyalkanoate may be poly-3-hydroxypropionate (P3HP).

As also indicated herein, the polyhydroxyalkanoate may be a copolymer. The copolymer may include at least one hydroxyalkanoate monomeric unit, such as one having a monomeric unit as described above. In one embodiment, the copolymer may include at least two hydroxyalkanoate monomeric units, such as those having a monomeric unit as described above. In one particular embodiment, the copolymer may include at least a 3-hydroxybutyrate monomeric unit.

Examples of polyhydroxyalkanoate copolymers may include, but are not limited to, poly-3-hydroxybutyrate-co-3-hydroxypropionate (P3HB3HP), poly-3-hydroxybutyrate-co-4-hydroxybutyrate (P3HB4HB), poly-3-hydroxybutyrate-co-4-hydroxyvalerate (P3HB4HV), poly-3-hydroxybutyrate-co-3-hydroxyvalerate (P3HB3HV), poly-3-hydroxybutyrate-co-3-hydroxyhexanoate (P3HB3HH), poly-3-hydroxybutyrate-co-5-hydroxyvalerate (P3HB5HV), etc. In one embodiment, the polyhydroxyalkanoate may be poly-3-hydroxybutyrate-co-4-hydroxybutyrate (P3HB4HB). In another embodiment, the polyhydroxyalkanoate may be poly-3-hydroxybutyrate-co-3-hydroxyhexanoate (P3HB3HH).

When the polyhydroxyalkanoate is a copolymer, the monomeric composition is not necessarily limited by the present disclosure. For instance, a first monomeric unit may be present in an amount of greater than 0 mol %, such as 0.1 mol % or more, such as 0.2 mol % or more, such as 0.5 mol % or more, such as 1 mol % or more, such as 2 mol % or more, such as 3 mol % or more, such as 5 mol % or more, such as 8 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 93 mol % or more, such as 95 mol % or more, such as 96 mol % or more, such as 97 mol % or more, such as 98 mol % or more, such as 99 mol % or more, such as 99.5 mol % or more based on the total monomeric units of the polyhydroxyalkanoate. The first monomeric unit may be present in an amount of less than 100 mol %, such as 99.9 mol % or less, such as 99.8 mol % or less, such as 99.7 mol % or less, such as 99.5 mol % or less, such as 99 mol % or less, such as 98 mol % or less, such as 97 mol % or less, such as 96 mol % or less, such as 95 mol % or less, such as 93 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less, such as 10 mol % or less, such as 8 mol % or less, such as 5 mol % or less, such as 4 mol % or less, such as 3 mol % or less, such as 2 mol % or less, such as 1 mol % or less, such as 0.8 mol % or less, such as 0.5 mol % or less, such as 0.3 mol % or less, such as 0.2 mol % or less, such as 0.1 mol % or less based on the total monomeric units of the polyhydroxyalkanoate. In some embodiments, the first monomeric unit may be 3-hydroxybutyrate.

Similarly, a second monomeric unit may be present in an amount of greater than 0 mol %, such as 0.1 mol % or more, such as 0.2 mol % or more, such as 0.5 mol % or more, such as 1 mol % or more, such as 2 mol % or more, such as 3 mol % or more, such as 5 mol % or more, such as 8 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 93 mol % or more, such as 95 mol % or more, such as 96 mol % or more, such as 97 mol % or more, such as 98 mol % or more, such as 99 mol % or more, such as 99.5 mol % or more based on the total monomeric units of the polyhydroxyalkanoate. The second monomeric unit may be present in an amount of less than 100 mol %, such as 99.9 mol % or less, such as 99.8 mol % or less, such as 99.7 mol % or less, such as 99.5 mol % or less, such as 99 mol % or less, such as 98 mol % or less, such as 97 mol % or less, such as 96 mol % or less, such as 95 mol % or less, such as 93 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less, such as 10 mol % or less, such as 8 mol % or less, such as 5 mol % or less, such as 4 mol % or less, such as 3 mol % or less, such as 2 mol % or less, such as 1 mol % or less, such as 0.8 mol % or less, such as 0.5 mol % or less, such as 0.3 mol % or less, such as 0.2 mol % or less, such as 0.1 mol % or less based on the total monomeric units of the polyhydroxyalkanoate. In some embodiments, the second monomeric unit may be 3-hydroxyhexanoate.

Furthermore, the polyhydroxyalkanoate composition may include one or more polyhydroxyalkanoates. In particular, it should be understood that a mixture of two or more polyhydroxyalkanoates may be utilized. Such mixture may include at least two homopolymers, at least two copolymers, at least one homopolymer and at least one copolymer, etc. In one embodiment, the composition may contain one polyhydroxyalkanoate. In other embodiments, the composition may include a mixture of polyhydroxyalkanoates. For instance, more than one polyhydroxyalkanoate, such as two or three polyhydroxyalkanoates, may be utilized in the composition.

When multiple polyhydroxyalkanoates are utilized, the amount of each is not necessarily limited by the present disclosure. For instance, a first polyhydroxyalkanoate may be present in an amount of greater than 0 wt. %, such as 0.1 wt. % or more, such as 0.2 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 93 wt. % or more, such as 95 wt. % or more, such as 96 wt. % or more, such as 97 wt. % or more, such as 98 wt. % or more, such as 99 wt. % or more, such as 99.5 wt. % or more based on the total weight of the polyhydroxyalkanoates. The first polyhydroxyalkanoate may be present in an amount of less than 100 wt. %, such as 99.9 wt. % or less, such as 99.8 wt. % or less, such as 99.7 wt. % or less, such as 99.5 wt. % or less, such as 99 wt. % or less, such as 98 wt. % or less, such as 97 wt. % or less, such as 96 wt. % or less, such as 95 wt. % or less, such as 93 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the polyhydroxyalkanoates.

Similarly, a second polyhydroxyalkanoate may be present in an amount of greater than 0 wt. %, such as 0.1 wt. % or more, such as 0.2 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 93 wt. % or more, such as 95 wt. % or more, such as 96 wt. % or more, such as 97 wt. % or more, such as 98 wt. % or more, such as 99 wt. % or more, such as 99.5 wt. % or more based on the total weight of the polyhydroxyalkanoates. The second polyhydroxyalkanoate may be present in an amount of less than 100 wt. %, such as 99.9 wt. % or less, such as 99.8 wt. % or less, such as 99.7 wt. % or less, such as 99.5 wt. % or less, such as 99 wt. % or less, such as 98 wt. % or less, such as 97 wt. % or less, such as 96 wt. % or less, such as 95 wt. % or less, such as 93 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the polyhydroxyalkanoates.

Regarding the properties of the polyhydroxyalkanoate, it may be desired to have a melt flow that can allow for it to be processed in a relatively easy manner for the formation of a composition and resulting article as disclosed herein. In this regard, the polyhydroxyalkanoate may exhibit a relatively low melt viscosity as indicated by the melt flow rate. For instance, the melt flow rate of the polyhydroxyalkanoate may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 7 g/10 min or more, such as about 10 g/10 min or more. The melt flow rate may be about 20 g/10 min or less, such as about 18 g/10 min or less, such as about 15 g/10 min or less, such as about 13 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO 1133-1: 2022.

The polyhydroxyalkanoate may also have a relatively low melting temperature. For instance, the melting temperature may be about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more, such as about 150° C. or more, such as about 160° C. or more, such as about 170° C. or more, such as about 180° C. or more. The melting temperature may be about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 50° C. or less. The melting temperature may be determined using means known in the art, such as differential scanning calorimetry in accordance with ISO 11357-1:2023 at a rate of 5° C./min.

In addition, the glass transition temperature of the polyhydroxyalkanoate may be within a particular range. For instance, the glass transition temperature may be about −60° C. or more, such as about −50° C. or more, such as about −40° C. or more, such as about −30° C. or more, such as about −20° C. or more, such as about −10° C. or more, such as about 0° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 110° C. or more. The glass transition temperature may be about 120° C. or less, such as about 110° C. or less, such as about 100° C. or less, such as about 90° C. or less, such as about 80° C. or less, such as about 70° C. or less, such as about 60° C. or less, such as about 50° C. or less, such as about 40° C. or less, such as about 30° C. or less, such as about 20° C. or less, such as about 10° C. or less, such as about 0° C. or less, such as about 10°°C. or less, such as about −20° C. or less, such as about −30° C. or less, such as about 40°°C. or less, such as about −50° C. or less. The glass transition temperature may be determined using means known in the art, such as differential scanning calorimetry in accordance with ISO 11357-1:2023 at a rate of 5° C./min.

Aside from thermal behavior, the polyhydroxyalkanoate may have certain other properties and characteristics. For instance, the polyhydroxyalkanoate may have a particular density. For instance, the density may be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The polyhydroxyalkanoate may have a density of about 1.5 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the polyhydroxyalkanoate may have a certain number average molecular weight. For instance, the number average molecular weight may be 10,000 g/mol or more, such as 20,000 g/mol or more, such as 30,000 g/mol or more, such as 50,000 g/mol or more, such as 80,000 g/mol or more, such as 100,000 g/mol or more, such as 150,000 g/mol or more, such as 200,000 g/mol or more, such as 300,000 g/mol or more, such as 400,000 g/mol or more, such as 500,000 g/mol or more. The number average molecular weight may be 2,000,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 250,000 g/mol or less, such as 200,000 g/mol or less, such as 150,000 g/mol or less, such as 120,000 g/mol or less, such as 100,000 g/mol or less. The number average molecular weight may be determined using means generally known in the art, such as gel permeation chromatography.

Similarly, the weight average molecular weight may be 10,000 g/mol or more, such as 20,000 g/mol or more, such as 30,000 g/mol or more, such as 50,000 g/mol or more, such as 80,000 g/mol or more, such as 100,000 g/mol or more, such as 150,000 g/mol or more, such as 200,000 g/mol or more, such as 300,000 g/mol or more, such as 400,000 g/mol or more, such as 500,000 g/mol or more. The weight average molecular weight may be 2,000,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 250,000 g/mol or less, such as 200,000 g/mol or less, such as 150,000 g/mol or less, such as 120,000 g/mol or less, such as 100,000 g/mol or less. The weight average molecular weight may be determined using means generally known in the art, such as gel permeation chromatography.

The polydispersity of the polyhydroxyalkanoate may be 1 or more, such as 1.1 or more, such as 1.2 or more, such as 1.3 or more, such as 1.4 or more, such as 1.5 or more, such as 1.6 or more, such as 1.7 or more, such as 1.8 or more, such as 1.9 or more, such as 2 or more. The polydispersity may be 5 or less, such as 4.8 or less, such as 4.5 or less, such as 4.3 or less, such as 4 or less, such as 3.8 or less, such as 3.5 or less, such as 3.3 or less, such as 3 or less, such as 2.8 or less, such as 2.6 or less, such as 2.5 or less, such as 2.4 or less, such as 2.3 or less, such as 2.2 or less, such as 2.1 or less, such as 2 or less, such as 1.9 or less, such as 1.8 or less, such as 1.7 or less, such as 1.6 or less.

In addition, the polyhydroxyalkanoate utilized may exhibit a certain mechanical strength. For instance, the tensile strength may be 1 MPa or more, such as 2 MPa or more, such as 3 MPa or more, such as 4 MPa or more, such as 5 MPa or more, such as 8 MPa or more, such as 10 MPa or more, such as 13 MPa or more, such as 15 MPa or more, such as 18 MPa or more, such as 20 MPa or more, such as 23 MPa or more, such as 25 MPa or more, such as 28 MPa or more, such as 30 MPa or more, such as 33 MPa or more, such as 35 MPa or more, such as 38 MPa or more, such as 40 MPa or more, such as 43 MPa or more, such as 45 MPa or more, such as 48 MPa or more. The tensile strength may be 50 MPa or less, such as 48 MPa or less, such as 45 MPa or less, such as 43 MPa or less, such as 40 MPa or less, such as 38 MPa or less, such as 35 MPa or less, such as 33 MPa or less, such as 30 MPa or less, such as 28 MPa or less, such as 25 MPa or less, such as 23 MPa or less, such as 20 MPa or less, such as 18 MPa or less, such as 15 MPa or less, such as 13 MPa or less, such as 10 MPa or less, such as 8 MPa or less, such as 5 MPa or less, such as 3 MPa or less. The tensile strength may be determined in accordance with ASTM D638-14 (Type V dogbone) at a temperature of about 23° C.

In addition, the tensile modulus may be about 0.1 GPa or more, such as 0.2 GPa or more, such as 0.3 GPa or more, such as 0.4 GPa or more, such as 0.5 GPa or more, such as 0.8 GPa or more, such as 1 GPa or more, such as 1.2 GPa or more, such as 1.4 GPa or more, such as 1.6 GPa or more, such as 1.8 GPa or more, such as 2 GPa or more. The tensile modulus may be 3 GPa or less, such as 2.8 GPa or less, such as 2.5 GPa or less, such as 2.3 GPa or less, such as 2 GPa or less, such as 1.8 GPa or less, such as 1.5 GPa or less, such as 1.3 GPa or less, such as 1 GPa or less, such as 0.8 GPa or less, such as 0.5 GPa or less, such as 0.3 GPa or less. The tensile modulus may be determined in accordance with ASTM D638-14 (Type V dogbone) at a temperature of about 23° C.

Also, the polyhydroxyalkanoate may have a relatively low strain at break. The strain at break may be about 0.3% or more, such as 0.5% or more, such as 0.8% or more, such as 1% or more, such as 1.3% or more, such as 1.5% or more, such as 1.8% or more, such as 2% or more, such as 2.5% or more, such as 3% or more, such as 3.5% or more, such as 4% or more, such as 5% or more, such as 6% or more, such as 7% or more, such as 8% or more, such as 9% or more, such as 10% or more, such as 11% or more, such as 12% or more, such as 13% or more, such as 15% or more, such as 18% or more, such as 20% or more, such as 23% or more, such as 25% or more, such as 30% or more. The strain at break may be 50% or less, such as 45% or less, such as 40% or less, such as 35% or less, such as 30% or less, such as 25% or less, such as 23% or less, such as 20% or less, such as 18% or less, such as 15% or less, such as 13% or less, such as 10% or less, such as 9% or less, such as 8% or less, such as 7% or less, such as 6% or less, such as 5% or less, such as 4% or less, such as 3% or less, such as 2% or less, such as 1% or less. The strain at break may be determined in accordance with ASTM D638-14 (Type V dogbone) at a temperature of about 23° C.

The polyhydroxyalkanoate composition may generally comprise about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 98 wt. % or more, such as about 99 wt. % or more of the polyhydroxyalkanoate(s) based on the weight of the polyhydroxyalkanoate composition. The polyhydroxyalkanoate composition may comprise 100 wt. % or less, such as about 99 wt. % or less, such as about 98 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less of the polyhydroxyalkanoate(s) based on the weight of the polyhydroxyalkanoate composition.

### B. Additives

In addition to the polyhydroxyalkanoate, the polyhydroxyalkanoate composition may optionally comprise one or more additives, such as those mentioned below. In this regard, in one embodiment, the polyhydroxyalkanoate composition may further comprise one or more additives. For instance, the additives may include those typically utilized in the art in order to provide a resulting composition or material (e.g., fiber/filament, yarn, fabric, and/or article) having the desired properties. These additives may include, but are not limited to, fillers, reinforcing agents, process aids, plasticizers, stabilizers (e.g., heat stabilizers; UV light stabilizers; metal deactivators; antioxidants such as phenolic, phosphite, and/or amine containing antioxidants; etc.), viscosity modifiers, lubricants, flow enhancing additives, flame retardants, impact modifiers, antistatic agents, antimicrobial agents, colorants, pigments, etc.

When utilized, the respective additive may be present in the polyhydroxyalkanoate composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the polyhydroxyalkanoate composition. The respective additive may be present in the polyhydroxyalkanoate composition in an amount of about 20 wt. % or less, such as about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyhydroxyalkanoate composition. In another embodiment, the aforementioned weight percentages may be based on the weight of the polyhydroxyalkanoate(s) in the polyhydroxyalkanoate composition. In addition, it should be understood that in one embodiment, a respective additive may be present in the polyhydroxyalkanoate composition in an amount of 0 wt. %.

In addition to the polyhydroxyalkanoate, the polyhydroxyalkanoate composition may include other polymers. For instance, the additional polymer may be a polyester, a polyamide, etc. in one embodiment. In one particular embodiment, the additional polymer may be a polyester. For instance, the polyester may be polyethylene terephthalate, polylactic acid, or a mixture thereof. In one embodiment, the additional polymer may be polyethylene terephthalate. In another embodiment, the additional polymer may be polylactic acid.

When utilized, the additional polymer may be present in the polyhydroxyalkanoate composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more, such as about 8 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more based on the weight of the polyhydroxyalkanoate composition. The additional polymer may be present in the polyhydroxyalkanoate composition in an amount of about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyhydroxyalkanoate composition. In another embodiment, the aforementioned weight percentages may be based on the weight of the polyhydroxyalkanoate(s) in the polyhydroxyalkanoate composition. In addition, it should be understood that in one embodiment, a respective additional polymer may be present in the polyhydroxyalkanoate composition in an amount of 0 wt. %.

However, in certain embodiments, of the polymers present in the polyhydroxyalkanoate fiber and/or yarn and the polyhydroxyalkanoate composition as disclosed herein for making the polyhydroxyalkanoate fiber and/or yarn, the polyhydroxyalkanoate(s) may constitute a primary concentration of such respective fiber and/or yarn and composition. For instance, in one embodiment, of the polymers present, the polyhydroxyalkanoate(s) may constitute 80 wt. % or more, such as 85 wt. % or more, such as 90 wt. % or more, such as 92 wt. % or more, such as 94 wt. % or more, such as 95 wt. % or more, such as 96 wt. % or more, such as 97 wt. % or more, such as 98 wt. % or more, such as 98.5 wt. % or more, such as 99 wt. % or more, such as 99.5 wt. % or more, such as 99.8 wt. % or more, such as 99.9 wt. % or more, such as 99.99 wt. % or more of the polymers present, whether in such polyhydroxyalkanoate fiber and/or yarn or the polyhydroxyalkanoate composition. In some embodiments, the polyhydroxyalkanoate(s) may constitute 100 wt. % of the polymers present in the polyhydroxyalkanoate fiber and/or yarn and the polyhydroxyalkanoate composition.

### II. Composition Formation

The polyhydroxyalkanoate composition described herein can be processed using techniques generally known in the art. For instance, the components (polyhydroxyalkanoate and optional additives) may be melt-mixed (also referred to as melt-blended). Utilizing such an approach, the components may be well-dispersed throughout the composition.

Prior to such melt-blending, any respective components may also be dried in order to minimize any moisture content. The drying may be conducted using means generally known in the art. In addition, during drying, a vacuum may be utilized to assist in removing any moisture content.

Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, an extruder, such as a co-rotating extruder, a counter-rotating extruder, or a twin-screw extruder, a co-kneader, etc. The melt blending may be carried out at a temperature greater than the melting temperature of the polyhydroxyalkanoate and generally less than a degradation temperature. For instance, the temperature may range from 50° C. to 300° C., such as from 80° C. to 200° C., such as 100° C. to 150° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation, such as a spinneret for forming fibers (interchangeably referred to as filaments) and yarns as disclosed herein. In particular, once formed, the polyhydroxyalkanoate composition may be utilized to form fibers (or filaments) and yarns as further described herein.

### III. Fibers and Yarns

As indicated herein, the polyhydroxyalkanoate and corresponding composition are suitable for forming fibers and corresponding yarns. In particular, the polyhydroxyalkanoate and corresponding composition may be utilized to form continuous fibers (or filaments) and corresponding yarns. For instance, the properties of the polyhydroxyalkanoate allow it to be processed to form fibers/filaments at speeds and conditions as disclosed herein and thereafter allow the fibers/filaments to be processed to form yarns and resulting fabrics and articles.

Furthermore, in one embodiment, the yarn may be a monofilament (or monofiber) yarn. In this regard, the yarn may simply be formed from the polyhydroxyalkanoate and/or corresponding composition. In another embodiment, the yarn may be a multifilament (or multifiber) yarn. In this regard, the yarn may also be formed from the polyhydroxyalkanoate and/or corresponding composition. In one embodiment, such multifilament yarn may include a second type of material. For instance, such second type of material may be any material generally known in the art for forming fibers/filaments and yarns.

The fibers/filaments of the present disclosure can be made using conventional processes known in the art. For example, these processes may include general steps such as spinning and optionally drawing the polyhydroxyalkanoate composition, including the polyhydroxyalkanoate, into a fiber/filament. The fibers/filaments may also be treated mechanically and/or chemically to impart desirable characteristics depending on the desired properties and characteristics of the resulting article made from the fibers/filaments and yarns.

In one particular embodiment, the fibers/filaments and/or yarns may be formed via melt spinning. Accordingly, the fibers/filaments may be melt spun fibers/filaments. Generally, melt spinning includes heating the polyhydroxyalkanoate and corresponding composition including the polyhydroxyalkanoate to form a melt (also referred to as a polymer melt) wherein such melting can be conducted by heating the polyhydroxyalkanoate against a heated surface. As an example, the polyhydroxyalkanoate may be heated in a mixer or an extruder and thereafter provided or metered to a spinneret. The temperature of operation may correspond to the melting temperature of the polyhydroxyalkanoate; for instance, the temperature may be relatively higher than the melting temperature of the polyhydroxyalkanoate in order to allow for the formation of a polymer melt. Regardless, the operation temperature may be within the ranges of the melting temperature of the polyhydroxyalkanoate as defined above.

The spinneret may include a plurality of orifices or capillaries having a particular size and design that allows for the formation of a fiber/filament having the desired configuration and cross-section. Accordingly, this process allows fibers/filaments of various sizes and cross sections to be formed, including fibers/filaments having, for example, round, elliptical, square, rectangular, lobed or dog-boned cross sections, etc.

The polyhydroxyalkanoate can be spun at speeds of from about 200 to about 6000 meters per minute (m/min), depending on the desired fiber/filament size. When forming the fibers/filaments, the spinning speed may be at least about 200 m/min, such as at least about 400 m/min, such as at least about 500 m/min, such as at least about 600 m/min, such as at least about 800 m/min, such as at least about 1000 m/min, such as at least about 2000 m/min. The spinning speed may be about 6000 m/min or less, such as about 5000 m/min or less, such as about 4000 m/min or less, such as about 3000 m/min or less, such as about 2500 m/min or less, such as about 2000 m/min or less, such as about 1800 m/min or less, such as about 1600 m/min or less, such as about 1400 m/min or less, such as about 1200 m/min or less, such as about 1000 m/min or less.

Once extruded through the spinneret, the fibers/filaments may be quenched. For instance, the fibers/filaments can be contacted with a non-reactive gas stream (e.g., air) or a liquid (e.g., water) to assist in solidifying the fibers/filaments. As an example, a fiber/filament may be quenched using a non-reactive gas stream, such as air. In another embodiment, quenching may be conducted using a liquid, such as water. The water may be cold water, such as having a temperature of 15° C. or less, such as 10° C. or less, such as 5° C. or less, such as 0° C. or less. In certain embodiments, both air quenching and liquid quenching may be utilized. For instance, air quenching may be conducted first followed by liquid quenching. In other embodiments, liquid quenching may be conducted first followed by air quenching. In addition, in one embodiment, additional quenching may not be necessary and sufficient quenching may be conducted based on ambient conditions. Thereafter, the fibers/filaments are collected downstream from the spinneret using one or more rollers.

Following extrusion from the spinneret, the fiber/filament may be drawn. The drawing may assist with achieving desirable properties, such as increasing modulus, strength, etc. However, it should be understood that in certain embodiments, drawing may not be conducted such that the fiber/filament produced is an undrawn fiber/filament. In such embodiments, the fiber/filament may still nonetheless have certain desirable properties. When conducted, the drawing can be done in combination with take-up by using a series of rollers or it can be done as a separate stage in the process of the fiber/filament formation.

The fibers/filaments may be drawn at any desired draw ratio depending on the desired properties, short of that which interferes with processing by breaking a fiber/filament. In this regard, the fibers/filaments may be drawn from 0× to about 10×, such as from about 0.5× to about 10×, such as from about 1.0× to about 10×. For instance, the fibers/filaments may be drawn at 0× or more, such as at least about 0.1×, such as at least about 0.2×, such as at least about 0.3×, such as at least about 0.5×, such as at least about 0.7×, such as at least about 0.9×, such as at least about 1.1×, such as at least about 1.2×, such as at least about 1.3×, such as at least about 1.4×, such as at least about 1.5×, such as at least about 1.8×, such as at least about 2×, such as at least about 2.2×, such as at least about 2.4×, such as at least about 2.5×, such as at least about 2.8×, such as at least about 3×, such as at least about 3.5×, such as at least about 4×, such as at least about 4.5×, such as at least about 5×, such as at least about 6×, such as at least about 8×. The fibers/filaments may be drawn about 10× or less, such as about 9× or less, such as about 8× or less, such as about 7.5× or less, such as about 7× or less, such as about 6.5× or less, such as about 6× or less, such as about 5.5× or less, such as about 5× or less, such as about 4.5× or less, such as about 4× or less, such as about 3.5× or less, such as about 3× or less, such as about 2.8× or less, such as about 2.6× or less, such as about 2.4× or less, such as about 2.2× or less, such as about 2× or less, such as about 1.8× or less, such as about 1.6× or less, such as about 1.4× or less, such as about 1.2× or less, such as about 1× or less, such as about 0.8× or less, such as about 0.6× or less, such as about 0.4× or less, such as about 0.2× or less. Such drawing may be conducted in a single step draw in one embodiment. In another embodiment, however, the fibers/filaments may not be drawn.

The fibers/filaments may be drawn in at least one drawing step, for example between a first roll, such as a feed roll, (which can be operated at 150 to 1000 m/minute) and a second roll, such as a draw roll, to form a drawn fiber/filament. The drawing step can be coupled with spinning to make a drawn yarn. Herein, the draw ratio may be the draw roll peripheral speed divided by the feed roll peripheral speed.

The fiber/filament, which may or may not be drawn, optionally can be at least partly relaxed. The relaxation may be conducted using means generally known in the art. Any amount of heat-relaxation can be carried out during spinning. In this regard, the fiber/filament may be dry or wet heat-treated while relaxed to develop the desired properties. Such relaxation can be accomplished during fiber/filament production, for example during the above-described relaxation step or after the fiber/filament has been incorporated into a yarn or a fabric. Heat-treatment in fiber/filament or yarn form can be carried out using means generally known in the art. It may be preferred that such relaxed heat-treatment be performed after the fiber/filament is in a yarn or a fabric so that up to that time it can be processed like a fiber/filament; however, if desired, it can be heat-treated and relaxed before being wound up as a fiber/filament. For greater uniformity in the final fabric, the fiber/filament can be uniformly heat-treated and relaxed.

The heat-treating/relaxation temperature can be in a desirable range. For instance, the range may be higher than the glass transition temperature of the polyhydroxyalkanoate and less than the melting temperature of the polyhydroxyalkanoate. The heating medium is not necessarily limited. For instance, it may include air, such as dry air or steam in one embodiment. In another embodiment, it may include a liquid, such as water.

In addition, relaxation of the fibers/filaments may be conducted by utilizing a contact surface having an elevated temperature. For instance, the contact surface may be a mold on which the fiber/yarn or fabric is placed. Such placement may allow for the fiber/yarn to be heat-treated/relaxed. Without intending to be limited by theory, such relaxation may allow for an increase in crystallinity of the polymer, such as the polyhydroxyalkanoate. With the increase in crystallinity, without intending to be limited by theory, the polymer chains may better align and be less amorphous, thereby potentially resulting in shrinkage of the chain and accordingly the resulting fiber/yarn and fabric.

The heat-treating/relaxation step can generally be accomplished in a few seconds. Such treatment may be for 0.5 seconds or more, such as 1 second or more, such as 2 seconds or more, such as 3 seconds or more, such as 4 seconds or more, such as 5 seconds or more, such as 8 seconds or more, such as 10 seconds or more, such as 15 seconds or more, such as 20 seconds or more, such as 25 seconds or more, such as 30 seconds or more, such as 40 seconds or more, such as 50 seconds or more, such as 1 minute or more, such as 2 minutes or more, such as 5 minutes or more, such as 10 minutes or more, such as 15 minutes or more, such as 20 minutes or more, such as 25 minutes or more, such as 30 minutes or more, such as 45 minutes or more, such as 1 hour or more, such as 1.25 hours or more, such as 1.5 hours or more, such as 1.75 hours or more, such as 2 hours or more. The treatment may be for 10 hours or less, such as 8 hours or less, such as 6 hours or less, such as 5 hours or less, such as 4 hours or less, such as 3 hours or less, such as 2.5 hours or less, such as 2 hours or less, such as 1.75 hours or less, such as 1.5 hours or less, such as 1.25 hours or less, such as 1 hour or less, such as 50 minutes or less, such as 40 minutes or less, such as 30 minutes or less, such as 20 minutes or less, such as 10 minutes or less, such as 5 minutes or less, such as 3 minutes or less, such as 2 minutes or less, such as 1 minute or less, such as 50 seconds or less, such as 40 seconds or less, such as 30 seconds or less, such as 20 seconds or less, such as 15 seconds or less, such as 10 seconds or less, such as 8 seconds or less, such as 5 seconds or less, such as 4 seconds or less, such as 3 seconds or less, such as 2 seconds or less.

Without intending to be limited, generally, the greater the relaxation, the more elastic the fiber/filament and the less shrinkage that may occur in downstream operations. For instance, as indicated above, the heat treatment/relaxation may allow for the polymer chains to relax and already shrink to the extent that it may not shrink to a considerable degree during downstream operations. In addition, without intending to be limited, such treatment may also allow the resulting article (e.g., garment), fabric, and/or yarn to be thermally stable for post-treatment processes, such as screen printing, sublimation dyeing, etc.

The quenched, optionally drawn, and optionally relaxed fibers/filaments can then be collected by winding at a winder. The winder (or winder roller) may also be referred to as a take up roll. The winding speed may be from about 200 to about 6000 meters per minute (m/min). For instance, the winding speed may be at least about 200 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The winding speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less.

The resulting fiber/filament and/or yarn is also amenable to further processing through the use of additional processing equipment, or it may be used directly in applications requiring a continuous fiber/filament and/or yarn.

Regarding further processing, the fiber/filament and/or yarn subsequently may be textured through known texturing conditions or processes. It may also be desirable to increase the surface area of the fiber/filament and/or yarn to provide a softer feel and to enhance the ability to breathe, thereby providing better insulation and water retention in the case of textiles. To increase the surface area, the fiber/filament and/or yarn may be crimped or twisted using techniques generally known in the art. Any additional processing methods utilized may be dictated by the particular application for the fiber/filament.

In addition, after formation, the fiber/filament and/or yarn may be treated by any method appropriate for the desired final use. For instance, in particular regarding textiles, this may include dyeing, coloring with pigments, sizing, or the addition of chemical agents such as antistatic agents, flame retardants, UV light stabilizers, antioxidants, pigments, dyes, stain resistants, and/or antimicrobial agents. In addition, the fibers/filaments and/or yarn may be treated to impart additional desired characteristics such as strength, elasticity or shrinkage.

While the fibers/filaments and yarns may be treated using such techniques, it should be understood that the resulting article, such as a fabric or textile, may also be treated using such techniques. For instance, while any independent treatment may be conducted on the fiber/filament during processing or post-processing, it should be understood that any such methods may also be conducted on a resulting article, such as a fabric or textile/article made from such fabric.

Generally, the method of making a fiber/filament or a yarn, such as a monofilament yarn, as disclosed herein may include at least the following: extruding a melt comprising the polyhydroxyalkanoate composition comprising the polyhydroxyalkanoate through a spinneret; withdrawing a fiber/filament from the spinneret; and collecting the fiber/filament on a roller, such as a winding roller. In addition, the method may also comprise quenching the fiber/filament. Such quenching may be conducted before drawing, if drawing is conducted, the fiber/filament. In certain embodiments, such quenching may simply be under ambient conditions. Also, the method may include a step of drawing the fiber/filament using a roller, such as a draw roller. Such drawing may be conducted after quenching.

Further, generally, the method of making a multifilament yarn as disclosed herein may include at least the following: extruding a melt comprising the polyhydroxyalkanoate composition comprising the polyhydroxyalkanoate through a spinneret; withdrawing a first fiber/filament and a second fiber/filament from the spinneret; and collecting the first fiber/filament and the second fiber/filament on a roller, such as a winding roller. In addition, the method may also comprise quenching the first fiber/filament and the second fiber/filament. Such quenching may be conducted before drawing, if drawing is conducted, the fiber/filament. In certain embodiments, such quenching may simply be under ambient conditions. Also, the method may include a step of drawing the first fiber/filament and the second fiber/filament using a roller, such as a draw roller. Such drawing may be conducted after quenching.

In addition, the method of making the multifilament yarn may also include a step of converging the fibers/filaments to form the multifilament yarn. Such converging of fibers/filaments may be conducted at any step of the process. In some embodiments, it may be conducted prior to being collected in a winding roll. For instance, it may be conducted after spinning, in particular after quenching. In one embodiment, it may be conducted after drawing. In another embodiment, it may be conducted before drawing. In other embodiments, the yarn may be prepared post collection on a winding roll, such that it is a post manufacturing process.

However, it should be understood that other methods of making multifilament yarns as known in the art may also be utilized. For instance, such methods may be utilized when the fibers/filaments of the multifilament yarn are formed from different materials. For instance, as indicated here, a respective yarn may include a first fiber formed from a fiber-forming material and a second fiber formed from a polyhydroxyalkanoate. In this regard, separate monofilaments or fibers of the first fiber as mentioned herein and a second fiber of the polyhydroxyalkanoate may be formed. Then, post formation, such respective fibers may be spun to form a respective multifilament yarn.

Further in accordance with the present disclosure, a melt spinning process is also disclosed for spinning fibers/filaments, in particular continuous fibers/filaments. In general, the process comprises passing a melt comprising a polyhydroxyalkanoate composition, including a polyhydroxyalkanoate, through a spinneret to form a plurality of fibers/filaments. A polyhydroxyalkanoate composition supply (e.g., in granular, pellet, or other form such as a melt) may be introduced to a spinneret. The molten fibers/filaments may be extruded through the spinneret. The polyhydroxyalkanoate may be extruded as undrawn fibers/filaments from the spinneret having orifices designed to give a desired cross section. In addition, the process may further include quenching the fibers/filaments after they exit the capillary of the spinneret to cool and/or solidify the fibers/filaments in any known manner, for example by air. Any suitable quenching method may be used. In one embodiment, the quenching may not be via forced air quenching; it may simply be conducted in ambient conditions.

As indicated herein, the fibers/filaments may be utilized to make a yarn. A yarn may include, but is not limited to, a number of fibers/filaments twisted together (spun yarn), a number of fibers/filaments laid together without twist (a zero-twist yarn), a number of fibers/filaments laid together with a degree of twist, and a single fiber/filament with or without twist (a monofilament).

In one embodiment, a multifilament yarn as disclosed herein may have no twist. In another embodiment, the multifilament yarn as disclosed herein may have a relatively small degree of twist. For instance, the twist may be 1 or less twists per inch, such as 0.9 or less twists per inch, such as 0.8 or less twists per inch, such as 0.7 or less twists per inch, such as 0.6 or less twists per inch, such as 0.5 or less twists per inch, such as 0.4 or less twists per inch, such as 0.3 or less twists per inch, such as 0.2 or less twists per inch, such as 0.1 or less twists per inch, such as 0.05 or less twists per inch, such as 0.01 or less twists per inch. The twist may be 0 or more twists per inch, such as 0.01 or more twists per inch, such as 0.05 or more twists per inch, such as 0.1 or more twists per inch, such as 0.2 or more twists per inch, such as 0.3 or more twists per inch, such as 0.4 or more twists per inch, such as 0.5 or more twists per inch.

As indicated herein, the yarn may generally have any fiber/filament count. For instance, the yarn may be a monofilament yarn formed from a single fiber/filament. Alternatively, the yarn may be a multifilament yarn formed from two or more fibers/filaments wherein such two or more fibers/filaments may be wound to form the yarn. Accordingly, the multifilament yarn comprises a first fiber/filament and a second fiber/filament. In addition, the multifilament yarn may further comprise a third fiber/filament. In particular, the multifilament yarn may include a first fiber/filament, a second fiber/filament, and a third fiber/filament. In one embodiment, the fibers/filaments of the multifilament yarn may be formed from the same material.

In this regard, the multifilament yarn may comprise at least about 2 fibers/filaments. The multifilament yarns may comprise about 2 or more, such as about 3 or more, such as about 5 or more, such as about 10 or more, such as about 15 or more, such as about 20 or more, such as about 25 or more, such as about 50 or more, such as about 100 or more fibers/filaments. The multifilament yarn may comprise about 200 or less, such as about 100 or less, such as about 80 or less, such as about 60 or less, such as about 50 or less, such as about 40 or less, such as about 35 or less, such as about 30 or less, such as about 25 or less, such as about 20 or less, such as about 15 or less, such as about 10 or less, such as about 5 or less, such as about 4 or less, such as about 3 or less fibers/filaments.

The yarns may have a total denier of from about 1 to about 2000. For instance, the total denier may be about 1 or more, such as about 5 or more, such as about 10 or more, such as about 20 or more, such as about 30 or more, such as about 40 or more, such as about 50 or more, such as about 70 or more, such as about 100 or more, such as about 120 or more, such as about 140 or more, such as about 160 or more, such as about 180 or more, such as about 200 or more, such as about 300 or more, such as about 500 or more, such as about 800 or more, such as about 1000 or more, such as about 1300 or more, such as about 1500 or more, such as about 1800 or more, such as about 2000 or more. The total denier may be about 3000 or less, such as about 2800 or less, such as about 2500 or less, such as about 2200 or less, such as about 2000 or less, such as about 1800 or less, such as about 1600 or less, such as about 1400 or less, such as about 1200 or less, such as about 1000 or less, such as about 800 or less, such as about 600 or less, such as about 500 or less, such as about 450 or less, such as about 400 or less, such as about 350 or less, such as about 300 or less, such as about 275 or less, such as about 250 or less, such as about 225 or less, such as about 200 or less, such as about 180 or less, such as about 160 or less, such as about 140 or less, such as about 120 or less, such as about 100 or less, such as about 80 or less, such as about 60 or less, such as about 50 or less. The denier may be determined in accordance with D2259-02(2016) at a temperature of about 23° C.

In other words, the denier per filament (or fiber) may be 0.5 or more, such as 1 or more, such as 1.5 or more, such as 2 or more, such as 2.5 or more, such as 3 or more, such as 3.5 or more, such as 4 or more, such as 4.5 or more, such as 5 or more, such as 5.5 or more, such as 6 or more, such as 7 or more, such as 8 or more, such as 10 or more, such as 15 or more, such as 20 or more, such as 25 or more, such as 30 or more, such as 40 or more, such as 50 or more, such as 80 or more, such as 100 or more, such as 130 or more, such as 150 or more, such as 180 or more, such as 200 or more, such as 230 or more, such as 250 or more. The denier per filament (or fiber) may be 300 or less, such as 280 or less, such as 260 or less, such as 240 or less, such as 220 or less, such as 200 or less, such as 180 or less, such as 160 or less, such as 140 or less, such as 120 or less, such as 100 or less, such as 90 or less, such as 80 or less, such as 70 or less, such as 60 or less, such as 50 or less, such as 40 or less, such as 30 or less, such as 25 or less, such as 20 or less, such as 15 or less, such as 10 or less, such as 8 or less, such as 7 or less, such as 6 or less, such as 5 or less, such as 4 or less, such as 3 or less, such as 2 or less. The denier per filament may be determined in accordance with D2259-02(2016) at a temperature of about 23° C.

Further, the fiber/filament and/or corresponding yarn may exhibit desired mechanical properties and strength. For instance, the tensile strength may be about 25 MPa or more, such as about 50 MPa or more, such as about 75 MPa or more, such as about 100 MPa or more, such as about 125 MPa or more, such as about 150 MPa or more, such as about 175 MPa or more, such as about 200 MPa or more, such as about 225 MPa or more, such as about 250 MPa or more, such as about 275 MPa or more, such as about 300 MPa or more, such as about 325 MPa or more, such as about 350 MPa or more, such as about 375 MPa or more, such as about 400 MPa or more. The tensile strength may be about 1000 MPa or less, such as about 950 MPa or less, such as about 900 MPa or less, such as about 850 MPa or less, such as about 800 MPa or less, such as about 750 MPa or less, such as about 700 MPa or less, such as about 650 MPa or less, such as about 600 MPa or less, such as about 575 MPa or less, such as about 550 MPa or less, such as about 525 MPa or less, such as about 500 MPa or less, such as about 475 MPa or less, such as about 450 MPa or less, such as about 425 MPa or less, such as about 400 MPa or less, such as about 375 MPa or less, such as about 350 MPa or less, such as about 325 MPa or less. The tensile strength may be determined in accordance with ASTM D2653-07(2018) (30 mm gauge length, 100 mm/min strain rate) at a temperature of about 23° C.

In addition, the elongation at break of the fiber/filament and/or yarn as disclosed herein may be about 5% or more, such as about 10% or more, such as about 15% or more, such as about 20% or more, such as about 25% or more, such as about 50% or more, such as about 75% or more, such as about 100% or more, such as about 125% or more, such as about 150% or more, such as about 175% or more, such as about 200% or more, such as about 225% or more, such as about 250% or more, such as about 275% or more, such as about 300% or more, such as about 325% or more, such as about 350% or more, such as about 375% or more, such as about 400% or more, such as about 450% or more, such as about 500% or more, such as about 600% or more, such as about 800% or more. The elongation at break may be about 1000% or less, such as about 900% or less, such as about 800% or less, such as about 700% or less, such as about 600% or less, such as about 550% or less, such as about 500% or less, such as about 475% or less, such as about 450% or less, such as about 425% or less, such as about 400% or less, such as about 375% or less, such as about 350% or less, such as about 325% or less, such as about 300% or less, such as about 275% or less, such as about 250% or less. The elongation at break may be determined in accordance with ASTM D2653-07(2018) at a temperature of about 23° C.

In addition to the elongation at break, the fiber/filament and/or corresponding yarn may also exhibit a desired strength as indicated by the tenacity. For instance, the tenacity may be about 0.1 grams per denier (g/d) or more, such as about 0.2 g/d or more, such as about 0.3 g/d or more, such as about 0.4 g/d or more, such as about 0.5 g/d or more, such as about 0.6 g/d or more, such as about 0.7 g/d or more, such as about 0.8 g/d or more, such as about 0.85 g/d or more, such as about 0.9 g/d or more, such as about 0.95 g/d or more, such as about 1 g/d or more, such as about 1.05 g/d or more, such as about 1.1 g/d or more, such as about 1.15 g/d or more, such as about 1.2 g/d or more, such as about 1.25 g/d or more, such as about 1.3 g/d or more, such as about 1.35 g/d or more, such as about 1.4 g/d or more, such as about 1.45 g/d or more, such as about 1.5 g/d or more, such as about 1.6 g/d or more, such as about 1.8 g/d or more, such as about 2 g/d or more. The tenacity may be about 5 g/d or less, such as about 4 g/d or less, such as about 3.5 g/d or less, such as about 3 g/d or less, such as about 2.5 g/d or less, such as about 2 g/d or less, such as about 1.8 g/d or less, such as about 1.6 g/d or less, such as about 1.4 g/d or less, such as about 1.2 g/d or less, such as about 1.15 g/d or less, such as about 1.1 g/d or less, such as about 1.05 g/d or less, such as about 1 g/d or less. The tenacity may be determined in accordance with ASTM D2653-07(2018) at a temperature of about 23° C.

The fiber/filament may have a particular size.

For instance, the size may be 0.1 mm or more, such as 0.2 mm or more, such as 0.3 mm or more, such as 0.4 mm or more, such as 0.5 mm or more, such as 0.6 mm or more, such as 0.7 mm or more, such as 0.8 mm or more, such as 0.9 mm or more, such as 1 mm or more. The size may be 5 mm or less, such as 4.5 mm or less, such as 4 mm or less, such as 3.5 mm or less, such as 3 mm or less, such as 2.5 mm or less, such as 2 mm or less, such as 1.8 mm or less, such as 1.6 mm or less, such as 1.5 mm or less, such as 1.4 mm or less, such as 1.3 mm or less, such as 1.2 mm or less, such as 1.1 mm or less, such as 1 mm or less, such as 0.9 mm or less, such as 0.8 mm or less, such as 0.7 mm or less, such as 0.6 mm or less, such as 0.5 mm or less, such as 0.4 mm or less, such as 0.3 mm or less, such as 0.2 mm or less. In one embodiment, such aforementioned size may refer to the size of the yarn.

As indicated herein, the fabric includes a fabric section. The fabric section includes a first fiber (or a plurality of first fibers) comprising a fiber-forming material wherein the first fiber is at least partially coated with a polyhydroxyalkanoate. The polyhydroxyalkanoate on the first fiber (or plurality of first fibers) is provided due to melting of a polyhydroxyalkanoate fiber (or plurality of polyhydroxyalkanoate fibers) also initially present within the fabric. For instance, exposure to heating resulted in melting of the polyhydroxyalkanoate fiber(s) such that it coated the first fiber(s) comprising the fiber forming material.

In certain embodiments, the fabric may include a first fabric section and a second fabric section. The first fabric section comprises a plurality of fibers comprising a first fiber comprising a fiber-forming material and a second fiber comprising a polyhydroxyalkanoate and the second fabric section comprises the first fiber extending from the first fabric section wherein the first fiber is at least partially coated with the polyhydroxyalkanoate. The first fabric section may comprise a plurality of fibers comprising a plurality of first fibers and a plurality of second fibers. In addition, the second fabric section may comprise a plurality of first fibers extending from the first fabric section. Such plurality of first fibers may be at least partially coated with the polyhydroxyalkanoate.

The fiber-forming material for the first fiber may be any material generally known in the art for forming fibers/filaments and yarns. In one embodiment, it may be a thermoplastic material. In another embodiment, it may be an elastic material. In another embodiment, it may be a non-elastic material. In one embodiment, the fiber-forming material may not be a polyhydroxyalkanoate. In this regard, the fiber-forming material may be a non-polyhydroxyalkanoate. The fiber-forming material may be cellulosic (e.g., cotton), proteinaceous (e.g., wool, silk), polyester (e.g., polyethylene terephthalate, polytrimethylene terephthalate), polyamide (e.g., nylon, polycaprolactam, poly(hexamethylene adipamide), aramid), acrylic, acetate, rayon, etc. In one embodiment, the fiber-forming material may be a polyhydroxyalkanoate. However, such polyhydroxyalkanoate may have a higher melting temperature than the polyhydroxyalkanoate of the second fiber.

Further, the fiber-forming material may be a thermoplastic in one embodiment, such that it has a glass transition temperature and/or a melting temperature. In another embodiment, the fiber-forming material may be a thermoset such that it has a degradation temperature. Regardless, the fiber-forming material has a melting temperature and/or a degradation temperature.

In this regard, the fiber-forming material may have a melting temperature or degradation temperature higher than the melting temperature of the polyhydroxyalkanoate. For instance, the fiber-forming material may have a melting temperature that is at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the polyhydroxyalkanoate. The melting temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the polyhydroxyalkanoate. In the event the material is not a thermoplastic, the degradation temperature of such fiber-forming material may be at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the polyhydroxyalkanoate. The degradation temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the polyhydroxyalkanoate. As a result, as further described below, such first fiber and corresponding fiber-forming material may not melt or degrade in the fabric section, such as the second fabric section, when subjected to elevated temperatures during processing, such as for forming selective areas within the fabric for obtaining desired properties.

The fibers/filaments formed from the fiber-forming material can be made using conventional processes known in the art. For example, these processes may include general steps such as spinning and optionally drawing the fiber-forming material into a fiber/filament. The fibers/filaments may also be treated mechanically and/or chemically to impart desirable characteristics such as strength, elasticity, heat resistance, feel, etc. depending on the desired properties and characteristics of the resulting article made from the fibers/filaments and yarns.

The resulting fibers and/or yarns may include a polyhydroxyalkanoate-based fiber and/or yarn in a particular amount. For instance, the polyhydroxyalkanoate may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the yarn. The polyhydroxyalkanoate may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less. In one embodiment, the aforementioned may be based on the weight of the fibers. In another embodiment, the aforementioned may be based on the weight of a respective fabric section. In a further embodiment, the aforementioned may be based on the weight of a fabric.

### IV. Articles

The advantageous properties of the fabric as disclosed herein can allow for it to be utilized to form various articles for various applications. In general, the fabric and respective fabric sections are formed from a plurality of fibers as mentioned herein. For instance, such plurality of fibers and/or yarns include a first fiber formed from a fiber-forming material and a second fiber formed from a polyhydroxyalkanoate. In this regard, such plurality of fibers and/or yarns may be presented in various configurations.

For example, in one embodiment, a yarn, such as a first yarn, may be provided including the first fiber formed from a fiber-forming material and the second fiber formed from a polyhydroxyalkanoate. Accordingly, such single yarn may include both types of fibers. In another embodiment, the fabric and respective fabric section may include two yarns. For instance, it may include a first yarn and a second yarn. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric and respective fabric sections in various configurations.

Nevertheless, the fibers/filaments may be utilized to form yarns which may be used to prepare woven, knit, and/or nonwoven fabrics and resulting articles which can be prepared using conventional techniques including, but not limited to, meltblown, spunbonded, card and bond, air entanglement, and other techniques. For instance, they may be subjected to various high-speed conditions for the formation of such articles.

In addition, the configuration of the yarn may depend on the particular application. For instance, the yarn may be utilized as a bare yarn or a covered yarn. In one embodiment, the yarns may be utilized themselves as bare yarns. Alternatively, the yarns may be used as covered yarns wherein the yarn as described herein may be utilized as the core. For such covered yarn, an inelastic fiber/filament or yarn or a short fiber yarn may wrap the core, in particular in a spiral manner. In addition or alternatively, another elastic yarn may also be utilized to cover.

Further, the yarns may be utilized to make fabrics, such as knit fabrics or woven fabrics. Further, the knit construction of the fabrics using the yarns is not necessarily limited by the present disclosure. For instance, various types of knit constructions as known in the art may be utilized to form a fabric and/or resulting article utilizing the fibers/filaments and yarns as disclosed herein. As one example, the knit construction may be a circular knit construction.

Generally, knitting is a process for constructing a fabric by interlocking a series of loops (bights) of one or more strands organized in wales and courses. In general, knitting includes warp knitting and weft knitting. In warp knitting, a plurality of strands runs lengthwise in the fabric to make all the loops. In weft knitting, one continuous strand runs crosswise in the fabric, making all the loops in one course. Weft knitting includes fabrics formed on both circular knitting and flat knitting machines. With circular knitting machines, the fabric is produced in the form of a tube, with the strands running continuously around the fabric. With a flat knitting machine, the fabric is produced in flat form, the threads alternating back and forth across the fabric. The resulting textile includes an interior side (the technical back) and an exterior side (the technical face), each layer being formed of the same or varying strands and/or stitches. By way of example, the knit structure may be a single knit/jersey fabric, a double knit/jersey fabric, and/or a plated fabric (with yarns of different properties are disposed on the face and back).

Within the strands, fibers/filaments and/or yarns other than those disclosed herein may be incorporated. For instance, the knit structure may include strands of the first fiber of a fiber-forming material and a second fiber of a polyhydroxyalkanoate as disclosed herein. However, the knit structure may also include strands of other materials than disclosed herein. In such structures, the other materials may also have a melting temperature and/or degradation temperature greater than the melting temperature of the polyhydroxyalkanoate. In one embodiment, all of the strands within the knit structure may be formed from a first fiber and a second fiber as disclosed herein.

In other words, a strand may include a plurality of fibers. Such plurality of fibers may include a first fiber of a fiber-forming material and a second fiber of a polyhydroxyalkanoate as disclosed herein. In one embodiment, the strand may include a first yarn and a second yarn, wherein such yarns are brought together to form the fabric and/or fabric section. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric and respective fabric sections in various configurations.

Particularly, with respect to one embodiment of a fabric structure as disclosed herein, a loop may include a plurality of fibers. Such plurality of fibers may include a first fiber of a fiber-forming material and a second fiber of a polyhydroxyalkanoate as disclosed herein. In one embodiment, the loop may include a first yarn and a second yarn, wherein such yarns are brought together to form the fabric and/or fabric section. The first yarn may include a plurality of fibers including a first fiber formed from a fiber-forming material. The second yarn may include a second fiber formed from a polyhydroxyalkanoate. In one embodiment, the second yarn may also include a plurality of fibers including a second fiber formed from a polyhydroxyalkanoate. Accordingly, such respective fibers may be present in the fabric and respective fabric sections in various configurations.

As indicated, other types of strands and yarns may also be utilized. For instance, in the knit structure, in one embodiment, at least one strand may be another strand typically used in the art. For instance, such strand may be formed of a synthetic material. Such strand may be formed from an elastic and may be any as generally known in the art. Alternatively, in one embodiment, such strand may be an inelastic strand, typically not formed of an elastomeric material.

These strands may include natural fibers including cellulosic fibers (e.g., cotton) and protein fibers (e.g., wool, silk) as well as synthetic fibers including polyester fibers (poly(ethylene terephthalate) fibers and poly(trimethylene terephthalate) fibers), polycaprolactam fibers, poly(hexamethylene adipamide) fibers, acrylic fibers, acetate fibers, rayon fibers, nylon fibers and combinations thereof.

Regardless of the structure (e.g., knit, woven, non-woven), the fabric may include a polyhydroxyalkanoate-based fiber and/or yarn in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The polyhydroxyalkanoate-based fiber and/or yarn may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

Related, the polyhydroxyalkanoate may be present in the fabric in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The polyhydroxyalkanoate may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

Further, as indicated herein, the fabric of the present disclosure, either prior to forming a resulting article or after forming the article, includes a fabric section. The fabric section may be obtained by subjecting the fabric section to a subsequent process after formation, particularly wherein the fabric section is subjected to a temperature greater than room temperature. In particular, the fabric section is subjected to a temperature equal to or greater than the melting temperature of the polyhydroxyalkanoate. In one embodiment, the fabric section is subjected to a temperature greater than the melting temperature of the polyhydroxyalkanoate. However, the temperature may be less than the melting temperature of any other fiber-forming material present within such fabric section.

In certain embodiments, the fabric includes a first fabric section and a second fabric section, each having different mechanical properties. Such difference may be obtained by subjecting the second fabric section to a subsequent process after formation, particularly wherein the second fabric section is subjected to a temperature greater than room temperature. In particular, the second fabric section is subjected to a temperature equal to or greater than the melting temperature of the polyhydroxyalkanoate. In one embodiment, the second fabric section is subjected to a temperature greater than the melting temperature of the polyhydroxyalkanoate. However, the temperature may be less than the melting temperature of any other fiber-forming material present within such fabric section.

By subjecting, it may be understood that this may cover various methods of providing such increased temperature. For instance, it may include contacting the fabric section, such as the second fabric section, with a heating element or component having a particular temperature as described below. In other words, it may include placing the fabric section, such as the second fabric section, in contact with a surface having a particular temperature as described below. Meanwhile, in one embodiment, other parts of the fabric, such as the first fabric section, may not be subjected to such temperature. To the extent the first fabric section is subjected to an elevated temperature greater than room temperature, such temperature may be less than the melting temperature of the polyhydroxyalkanoate.

In this regard, the fabric section, such as the second fabric section, subjected to an elevated temperature may be subjected to a temperature of about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more, such as about 150° C. or more, such as about 160° C. or more, such as about 170° C. or more, such as about 180° C. or more. The temperature may be about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 50° C. or less.

In one embodiment, the fabric section, such as the second fabric section, may also be subjected to a pressure greater than atmospheric pressure. By subjecting, in one embodiment, the pressure may be applied to a particular area of the fabric section, such as the second fabric section.

For instance, such application may be via compacting or pressing using means generally known in the art. For instance, these may include a heated (or platen) press, an iron, calendering, as well as other means known in the art. In this regard, such subjection and application may be via contact means in one embodiment. Other examples may also include placing the fabric over a mold that may be heated to a desired temperature. In another embodiment, such subjection and application may also be via non-contact means.

Such application of heat and/or pressure may be for 0.5 seconds or more, such as 1 second or more, such as 5 seconds or more, such as 10 seconds or more, such as 15 seconds or more, such as 20 seconds or more, such as 25 seconds or more, such as 30 seconds or more, such as 35 seconds or more, such as 40 seconds or more, such as 50 seconds or more, such as 60 seconds or more, such as 70 seconds or more, such as 80 seconds or more, such as 90 seconds or more, such as 100 seconds or more, such as 120 seconds or more, such as 140 seconds or more, such as 160 seconds or more, such as 180 seconds or more. The subjecting/application may be for 400 seconds or less, such as 360 seconds or less, such as 320 seconds or less, such as 280 seconds or less, such as 240 seconds or less, such as 200 seconds or less, such as 160 seconds or less, such as 140 seconds or less, such as 120 seconds or less, such as 100 seconds or less, such as 80 seconds or less, such as 60 seconds or less, such as 40 seconds or less, such as 20 seconds or less, such as 15 seconds or less, such as 10 seconds or less, such as 5 seconds or less, such as 4 seconds or less, such as 3 seconds or less.

By subjecting or exposing the fabric section, such as the second fabric section, to such temperature and optionally such pressure, in certain embodiments to such temperature and pressure, the fabric section, such as the second fabric section, may then exhibit different properties, particularly mechanical properties compared to the fabric pre-treatment. In addition, to the extent a first fabric section as defined herein is present, the second fabric section may also exhibit different properties, particularly mechanical properties, compared to the first fabric section as described herein. In particular, without intending to be limited by theory, such exposure may soften and/or melt the polyhydroxyalkanoate of the fiber and yarn in the fabric, particular the second fabric section. After removing the heat and pressure, if present, the polyhydroxyalkanoate of the fiber or yarn in the fabric may then again solidify. However, due to melting, the polyhydroxyalkanoate utilized in forming the second fiber within the fabric section, such as the second fabric section, may melt and thereby at least partially coat the first fiber within the fabric section, such as the second fabric section. However, such first fiber may still remain intact in an unmolten state. In the event a first fabric section is present that is not exposed to the elevated temperature, the first fiber may extend to the first fabric section. However, in the first fabric section, the second fiber may also remain intact in an unmolten state.

Furthermore, as indicated herein, the first fiber of the first yarn is present in the fabric section, particularly in the second fabric section and if present, the first fabric section. Accordingly, the second fiber from the polyhydroxyalkanoate may have softened and/or melted and/or fused in the fabric section, such as the second fabric section, while it may not have softened, melted, and/or fused in the first fabric section if present. In addition, the first fiber of the fiber-forming material may also be continuous such that it is present in the first fabric section and the second fabric section. Also, in one embodiment, such application of heat and/or pressure may not be conducted in the first fabric section, particularly heat at a temperature equal to or greater than the melting temperature of the polyhydroxyalkanoate.

Further, such application of heat and/or pressure and formation of second fabric sections may be continuous or discontinuous. For instance, such second fabric sections may be formed at different areas or portions of the fabric. In this regard, a resulting fabric and article may include more than one second fabric section. Accordingly, such formation of second fabric sections may be intentional to provide desired properties in selective areas.

The fabric formed from the fibers/filaments and/or corresponding yarns as disclosed herein can be incorporated into a resulting article. Accordingly, the resulting article may comprise or be formed from the fabric. The article may not necessarily be limited by the present disclosure.

Also, it should be understood that such aforementioned process may be conducted on a fabric prior to formation of a resulting article, such as an apparel or garment. After conducting such aforementioned process, the resulting article may be formed from the fabric, such as one having the multiple fabric sections. In another embodiment, such aforementioned process may be conducted on a fabric after formation of the resulting article, such as an apparel or garment. In this regard, the resulting article may comprise and be formed from the fabric, such as one including having the multiple fabric sections.

As indicated herein, the melting and subsequent solidification, albeit in a different form, provides a fabric section, such as a second fabric section, with different properties. In essence, such process can allow for selective control of properties within a fabric and resulting article. In addition, as mentioned herein, such process can allow for such selective control within a continuous fabric and thus not require knitting, sewing, gluing, etc. of two fabrics in order to obtain such difference in properties in a resulting fabric and article.

Accordingly, the fabric and process as disclosed herein provides flexibility. For instance, there is flexibility in the process of forming such fabric and article, particularly having the different properties in selective areas. In addition, the process allows for selective control of such properties within desired sections of a fabric and resulting article.

As indicated herein, the fabric may be utilized in a number of articles. Primarily, the fabric may be utilized in articles such as clothing (also referred to as apparel and garments). The clothing may include, but is not limited to, shoes (e.g., shoe uppers), shirts, pants, socks, undergarments, skirts, hats, outerwear, etc. The fabric may also be utilized for other fabric-based goods, particularly soft goods accessories.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention as further described in such appended claims.

1. A polyhydroxyalkanoate-based fabric comprising:
a fabric section comprising a first fiber comprising a fiber forming material at least partially coated with a polyhydroxyalkanoate.

2. The polyhydroxyalkanoate-based fabric of claim 1, comprising
a first fabric section comprising a plurality of fibers comprising a first fiber comprising a fiber-forming material and a second fiber comprising a polyhydroxyalkanoate wherein the fiber-forming material has a melting temperature or a degradation temperature higher than a melting temperature of the polyhydroxyalkanoate, and
the fabric section comprising a second fabric section comprising the first fiber extending from the first fabric section wherein the first fiber is at least partially coated with the polyhydroxyalkanoate present in the second fabric section.

3. The polyhydroxyalkanoate-based fabric of claim 1, wherein the polyhydroxyalkanoate comprises a homopolymer.

4. The polyhydroxyalkanoate-based fabric of claim 1, wherein the polyhydroxyalkanoate comprises a copolymer.

5. The polyhydroxyalkanoate-based fabric of claim 1, wherein the polyhydroxyalkanoate has a monomeric unit of the following formula:
—OCR¹R²(CR³R⁴)ₙCO—
wherein
n is an integer; and
R¹, R², R³, and R⁴ independently can be a hydrocarbon radical; a halo-and hydroxy-substituted radical; a hydroxy radical; a halogen radical; a nitrogen-substituted radical; an oxygen-substituted radical; or a hydrogen atom.

6. The polyhydroxyalkanoate-based fabric of claim 5, wherein n is from 1 to 3.

7. The polyhydroxyalkanoate-based fabric of claim 5, wherein R¹, R², R³, and R⁴ independently can be hydrocarbon radicals or hydrogen atoms.

8. The polyhydroxyalkanoate-based fabric of claim 7, wherein the hydrocarbon radical is an alkyl radical.

9. The polyhydroxyalkanoate-based fabric of claim 1, wherein the polyhydroxyalkanoate comprises a 3-hydroxybutyrate monomeric unit.

10. The polyhydroxyalkanoate-based fabric of claim 1, wherein the polyhydroxyalkanoate comprises poly-3-hydroxybutyrate-co-3-hydroxyhexanoate.

11. The polyhydroxyalkanoate-based fabric of claim 2, wherein the second fabric section has a higher tensile modulus than the first fabric section.

12. The polyhydroxyalkanoate-based fabric of claim 2, wherein a ratio of a tensile modulus of the first fabric section to a tensile modulus of the second fabric section is less than 1.

13. The polyhydroxyalkanoate-based fabric of claim 2, wherein a ratio of the tensile modulus of the first fabric section to the tensile modulus of the second fabric section is from 0.1-0.5.

14. The polyhydroxyalkanoate-based fabric of claim 2, wherein the plurality of fibers comprises a first yarn comprising the first fiber and a second yarn comprising the second fiber.

15. The polyhydroxyalkanoate-based fabric of claim 2, wherein the plurality of fibers comprises a first yarn comprising the first fiber and the second fiber.

16. The polyhydroxyalkanoate-based fabric of claim 1, wherein the fabric is a knit fabric.

17. The polyhydroxyalkanoate-based fabric of claim 1, wherein the fabric is a woven fabric.

18. A method of making a continuous polyhydroxyalkanoate-based fabric, the method comprising:
providing a fabric comprising a fabric section comprising a first fiber comprising a fiber-forming material and a second fiber comprising a polyhydroxyalkanoate wherein the fiber-forming material has a melting temperature or a degradation temperature higher than a melting temperature of the polyhydroxyalkanoate, and
subjecting the fabric section to a temperature equal to or greater than the melting temperature of the polyhydroxyalkanoate such that the second fiber comprising the polyhydroxyalkanoate melts to at least partially coat the first fiber.

19. A method of making a continuous polyhydroxyalkanoate-based fabric, the method comprising:
providing a fabric comprising
a first fabric section comprising a plurality of fibers comprising a first fiber comprising a fiber-forming material and a second fiber comprising a polyhydroxyalkanoate wherein the fiber-forming material has a melting temperature or a degradation temperature higher than a melting temperature of the polyhydroxyalkanoate, and
a second fabric section comprising the first fiber extending from the first fabric section and the second fiber extending from the first fabric section, and
subjecting the second fabric section to a temperature equal to or greater than the melting temperature of the polyhydroxyalkanoate such that the second fiber comprising the polyhydroxyalkanoate of the second fabric section melts to at least partially coat the first fiber of the second fabric section.
